(19) United States
(12) Patent Application Publication
(10) Pub. No.: US 2007/0079632 A1
(43) Pub. Date: Apr. 12, 2007

(54) Thin silicon layer and method of manufacturing thereof

(76) Inventor: Sadeg M. Faris, Pleasantville, NY (US)

Correspondence Address: REVEO, INC., 3 WESTCHESTER PLAZA, ELMSFORD, NY, 10523, US

(21) Appl. No.: 11/409,733

(22) Filed: Apr. 24, 2006

Related U.S. Application Data
(60) Provisional application No. 60/674,256, filed on Apr. 22, 2005.

(51) Int. Cl. C03C 15/00; C03B 37/00; C03B 32/00

(52) U.S. Cl. 65/32.1; 65/111; 65/30.13

(57) ABSTRACT

A method of making a silicon sheet is disclosed. The method includes forming a thin glass sheet at semi-molten state. The glass sheet is exposed, at a semi-molten state, to a voltage across the thickness of the sheet. Impurities are cleaned at the surface, thereby leaving a silicon oxide sheet. The silicon oxide sheet is exposed to a reducing gas at a semi-molten temperature to reduce the oxide. A system for performing the method is also disclosed.

### RELATED APPLICATIONS

This application claims the benefit under 35 U.S.C. §119(e) of U.S. Provisional Application No. 60.674,256 filed on Apr. 22, 2005 entitled “Thin Silicon Layer and Method of Manufacturing Thereof”, which is incorporated herein by reference.

### TECHNICAL FIELD

This invention relates generally to the field of silicon processing, and more particularly to a method and system for creating a thin silicon layer.

### BACKGROUND ART

Silicon is the key to today's information society. As demand for devices based on silicon increase, the processing techniques continually improve.

Semiconductor devices are generally fabricated from wafers of monocrystalline silicon. Various procedures for preparing monocrystalline silicon wafers have been described in the prior art. A monocrystalline billet is provided, which must be sawed into slices and further processed by lapping, polishing, and/or etching to produce wafers suitable for the production of semiconductor devices.

With the present increasing demand for photovoltaic cells, large amounts of semiconductor material, preferably monocrystalline silicon, will be required. If such systems are to reduce in cost, a necessary factor to lead to ubiquity and energy independence, such silicon must be attainable at a cost far less than present costs for silicon wafers.

Therefore, attempts have been made to overcome the cost problems by creating silicon sheets. It is known that such sheets have been made by melting pure silicon powder and processing it into free standing sheets, such as by drawing or deposition on a substrate. While these methods produce sheets that are suitable for certain purposes, there remains a need in the art for improved methods resulting in pure and defect free crystalline silicon.

### BRIEF SUMMARY OF THE INVENTION

A method of making a silicon sheet is disclosed. The method includes forming a thin glass sheet at semi-molten state. The glass sheet is exposed, at a semi-molten state, to a voltage across the thickness of the sheet. Impurities are cleaned at the surface, thereby leaving a silicon oxide sheet. The silicon oxide sheet is exposed to a reducing gas at a semi-molten temperature to reduce the oxide.

### BRIEF DESCRIPTION OF THE FIGURES

The foregoing summary as well as the following detailed description of preferred embodiments of the invention will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings, where:

FIG. 1 is a schematic depiction of an exemplary silicon sheet produced according to the present invention;

FIG. 2 is a schematic depiction of a sheet of glass used as a starting material;

FIG. 3 is a schematic depiction of a process step whereby electrodes are used to apply a voltage across the thickness of the glass;

FIG. 4 is a schematic depiction of the glass after the step described with respect to FIG. 3;

FIGS. 5-6 show various embodiments of cleaning steps to obtain pure SiO₂;

FIGS. 7-8 show various embodiments of gassing steps to obtain pure Si;

FIG. 9 shows an exemplary method to form monocrystalline Si.

### DETAILED DESCRIPTION OF THE FIGURES

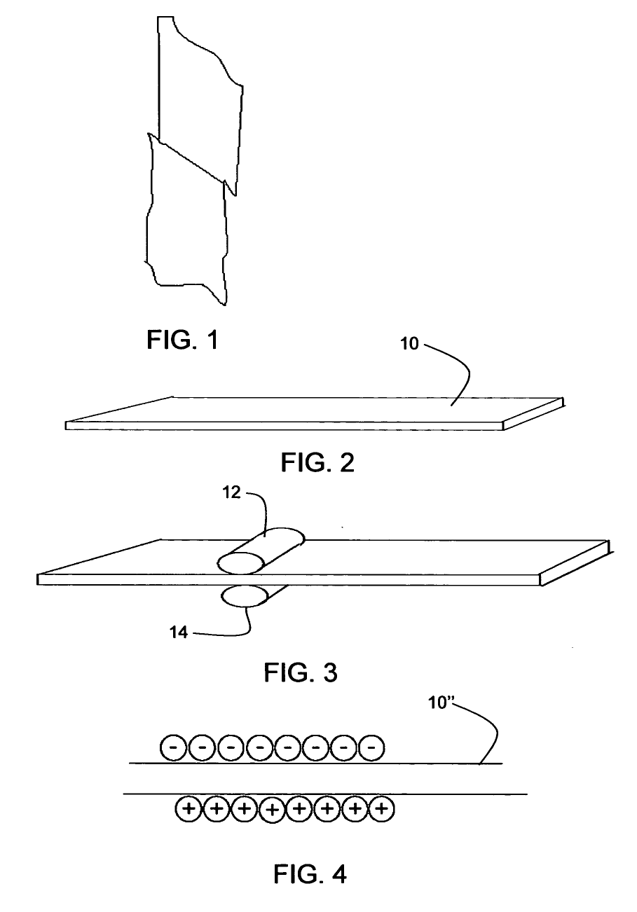

A method and system for manufacturing silicon sheets or ribbon is being proposed. As described herein, the method and system has the ability to produce pure sheets of silicon oxide, polycrystalline silicon, and even monocrystalline silicon in sheet form or even ribbon form (FIG. 1).

Referring to FIG. 2, the process starts with a sheet of glass 10. Sheet 10 may be formed by known methods, and may be formed into a continuous ribbon (in the molten or semi-molten state).

This glass sheet must be purified to obtain stoichiometric SiO₂. This is accomplished as shown schematically in FIG. 3, whereby the semi-molten sheet 10′ of glass is passed through opposing electrodes 12, 14. The electrodes 12, 14 are depicted in the Figure as rollers, however it should be understood by one skilled in the art that electrodes may be in the form of conductive bars, sheets, or other suitable form. The voltage applied across the electrodes may vary depending factors including but not limited to on the degree of purity desired, the thickness of the sheet, the form of the electrodes, and other processing conditions.

The resulting sheet 10″ is shown in FIG. 4, whereby impure ions are attracted to the surface. Furthermore, neutral ions will migrate to the surface by electro-thermo-migration forces.

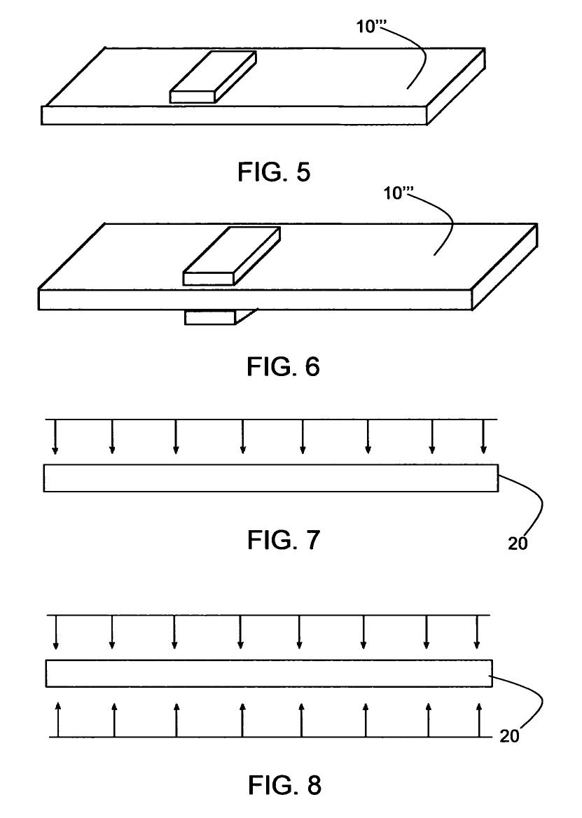

Referring now to FIGS. 5 and 6, various embodiments of a cleaning step are shown. As shown in FIG. 5, each side of sheet 10′″ may be cleaned separately. As shown in FIG. 6, both sides of sheet 10′″ may be cleaned simultaneously. Cleaning may be accomplished by known techniques including but not limited to chemical etching techniques, sputter etching techniques; plasma etching techniques, reactive ion etching techniques, mechanical techniques such as micro polishing, or combinations comprising at least one of the foregoing techniques. Cleaning may be accomplished at a solid state or a semi-molten state, depending on the technique selected. Preferably, after cleaning, substantially pure SiO₂ remains.

Thereafter, and referring now to FIGS. 7 and 8, the sheet 20 if SiO₂ may be subjected to a reduction step. For example, sheet 20 is subject to (one side at a time (FIG. 7) or both sides simultaneously (FIG. 8)) hydrogen gas. Preferably, this is at hight temperatures such that the sheet 20 is in semi-molten state. This will result in water vapor leaving the sheet and a pure Si sheet will remain.

The pure Si sheet may become monocrystalline due to the high processing temperatures. The sheet may anneal during the above processing, or may be subject to a separate annealing step. Preferably, if the sheet or film is thin enough, the grains of the structure may self orient to assume the lowest energy level.

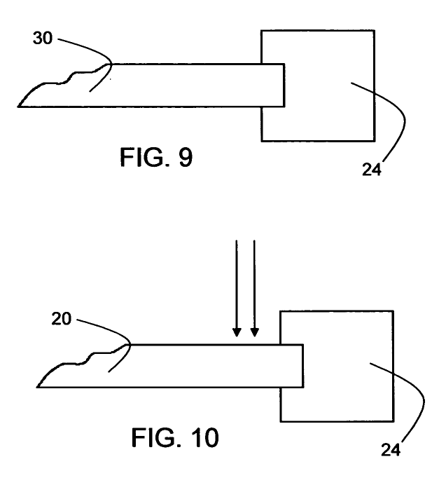

Further, in an alternative embodiment, a sheet 30 of pure Si obtained as described above may be created into a monocrystalline structure with a seed. For example, referring now to FIG. 9, a seed handler 24, of monocrystailine Si, is attached to an end of the sheet, which will propagate through the sheet.

Still further, and referring now to FIG. 10, a sheet 20 of SiO₂ formed as described above may have a seed handler 24, of monocrystalline Si, is attached to an end of the sheet. The sheet is then subject to reduction, e.g., by exposure to hydrogen at semi-molten state, thereby propagating s single crystal zone.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A method of making a silicon oxide sheet comprising:
forming a thin glass sheet at semi-molten state;
exposing the glass sheet semi-molten state to a voltage across the thickness of the sheet; and
cleaning impurities that are exposed at the surface.

2. A method of making a silicon sheet comprising:
forming a thin glass sheet at semi-molten state;
exposing the glass sheet semi-molten state to a voltage across the thickness of the sheet;
cleaning impurities that are exposed at the surface, thereby leaving a silicon oxide sheet;
exposing the silicon oxide sheet to a reducing gas at a semi-molten temperature to reduce the oxide.

3. The method as in claim 2, wherein the sheet is sufficiently thin so that monocrystalline silicon is formed due to self orientation.

4. The method as in claim 2, wherein the sheet is annealed so that monocrystalline silicon is formed.

5. The method as in claim 2, wherein the sheet is subject to a seed process so that monocrystalline silicon is formed.

6. The method as in claim 2, wherein the sheet is subject to a seed during the step of exposing to a reducing gas so that monocrystalline silicon is formed.

7. A system for making a silicon sheet comprising:
a device for forming a thin glass sheet at semi-molten state;
electrodes for exposing the glass sheet semi-molten state to a voltage across the thickness of the sheet;
a cleaning sub-system for cleaning impurities that are exposed at the surface, thereby leaving a silicon oxide sheet;
a reducing gas environment for exposing the silicon oxide sheet to a reducing gas at a semi-molten temperature to reduce the oxide.
